(19) United States
(12) Patent Application Publication
(10) Pub. No.: US 2022/0174253 A1
(43) Pub. Date: Jun. 2, 2022

(54) METHOD AND APPARATUS FOR TRANSMITTING AND RECEIVING IMAGE IN PLENOPTIC SYSTEM

(71) Applicant: ELECTRONICS AND TELECOMMUNICATIONS RESEARCH INSTITUTE, Daejeon (KR)

(72) Inventors: Soon Choul KIM, Daejeon (KR); Joon Young JUNG, Daejeon (KR); Dong Joon CHOI, Daejeon (KR)

(73) Assignee: ELECTRONICS AND TELECOMMUNICATIONS RESEARCH INSTITUTE, Daejeon (KR)

(21) Appl. No.: 17/538,362

(22) Filed: Nov. 30, 2021

(30) Foreign Application Priority Data
Nov. 30, 2020 (KR) 10-2020-0163722

(51) Int. Cl. H04N 13/194; H04N 13/139; H04N 13/366

(52) U.S. Cl. CPC H04N 13/194; H04N 13/366; H04N 13/139

(57) ABSTRACT

An image receiving method includes receiving, from a plenoptic server, a high-quality image stream of a first viewpoint; requesting, from the plenoptic server, information on a second viewpoint to be shifted when a user's view is shifted, and requesting, from an edge server, a medium-quality image stream of the shifted second viewpoint; receiving, from the edge server, the medium-quality image stream of the second viewpoint and playing the received medium-quality image stream; and receiving information on the second viewpoint and subsequently playing a high-quality image stream of the second viewpoint received from the plenoptic server.

### CROSS-REFERENCE TO RELATED APPLICATION

This application claims priority to and the benefit of Korean Patent Application No. 10-2020-0163722 filed in the Korean Intellectual Property Office on Nov. 30, 2020, the entire contents of which are incorporated herein by reference.

### BACKGROUND OF THE INVENTION

### (a) Field of the Invention

The present invention relates to a method and apparatus for transmitting and receiving an image in a plenoptic system.

### (b) Description of the Related Art

A plenoptic service is a service that encodes images obtained from a plurality of cameras and transmits encoded images and provides an image corresponding to a selected viewpoint according to a view-shift of a terminal. The plenoptic service may immediately stream an image according to a view shifting to a remote terminal in a limited network environment.

A large-capacity streaming service of a related art that provides a multi-viewpoint, such as plenoptic services, compresses images from all views and transmit the views at once in one image stream, but data capacity is larger than that of sending a single view image and a data download time in a terminal is longer, which may cause a delay in view switching.

To solve this problem, a method for using two or more video decoders at the same time so that the terminal may quickly change the view has been studied, but this may increase a terminal price.

The above information disclosed in this Background section is only for enhancement of understanding of the background of the invention, and therefore it may contain information that does not form the prior art that is already known in this country to a person of ordinary skill in the art.

### SUMMARY OF THE INVENTION

The present invention has been made in an effort to provide a method for receiving an image by a plenoptic terminal.

The present invention has also been made in an effort to provide a method for transmitting an image by a plenoptic server.

An embodiment of the present invention provides a method for receiving an image by a plenoptic terminal. The image receiving method includes receiving, from a plenoptic server, a high-quality image stream of a first viewpoint; requesting, from the plenoptic server, information on a second viewpoint to be shifted when a user's view is shifted, and requesting, from an edge server, a medium-quality image stream of the shifted second viewpoint; receiving, from the edge server, the medium-quality image stream of the second viewpoint and playing the received medium-quality image stream; and receiving the information on the second viewpoint and subsequently playing a high-quality image stream of the second viewpoint received from the plenoptic server.

Another embodiment of the present invention provides a method for transmitting an image by a plenoptic server. The image transmitting method includes transmitting, to a plenoptic terminal, a high-quality image stream of a first viewpoint and cashing a medium-quality image stream of the first viewpoint to an edge server; receiving, after a user's view is shifted, information on a second viewpoint to be shifted transmitted from the plenoptic terminal and providing a high-quality image stream of the second viewpoint to the plenoptic terminal; and cashing a shifted medium-quality image stream of the second viewpoint to the edge server.

### BRIEF DESCRIPTION OF THE DRAWINGS

FIG. 1 is a block diagram illustrating a plenoptic system according to an embodiment.

FIG. 2 is a conceptual diagram illustrating a shifting scenario of a viewpoint according to an embodiment.

FIG. 3 is a flowchart illustrating a high-quality image transmission/reception method provided by a plenoptic system according to an embodiment.

FIG. 4 is a conceptual diagram illustrating MPD data configured by a plenoptic server according to an embodiment.

FIG. 5 is a block diagram illustrating a plenoptic terminal according to an embodiment.

FIG. 6 is a block diagram illustrating a plenoptic terminal according to another embodiment.

### DETAILED DESCRIPTION OF THE EXEMPLARY EMBODIMENTS

In the following detailed description, only certain embodiments have been shown and described, simply by way of illustration. As those skilled in the art would realize, the described embodiments may be modified in various different ways, all without departing from the spirit or scope of the description. Accordingly, the drawings and description are to be regarded as illustrative in nature and not restrictive, and like reference numerals designate like elements throughout the specification.

Throughout the specification, unless explicitly described to the contrary, the word “comprise”, and variations such as “comprises” or “comprising”, will be understood to imply the inclusion of stated elements but not the exclusion of any other elements.

In this specification, expressions described in the singular may be construed in the singular or plural unless an explicit expression such as “one” or “single” is used.

As used herein, “and/or” includes each and every combination of one or more of the recited elements.

In the specification, it will be understood that, although the terms “first,” “second,” etc. may be used herein to describe various elements, these elements should not be limited by these terms. These terms are only used to distinguish one element from another. For example, a first element could be termed a second element, and a second element could similarly be termed a first element without departing from the scope of the present description.

In a flowchart described with reference to drawings in this specification, the order of operations may be changed, several operations may be merged, some operations may be divided, and specific operations may not be performed.

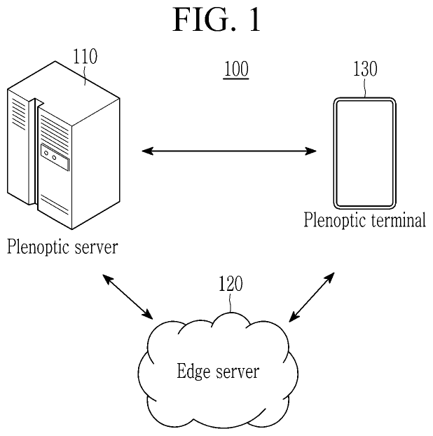

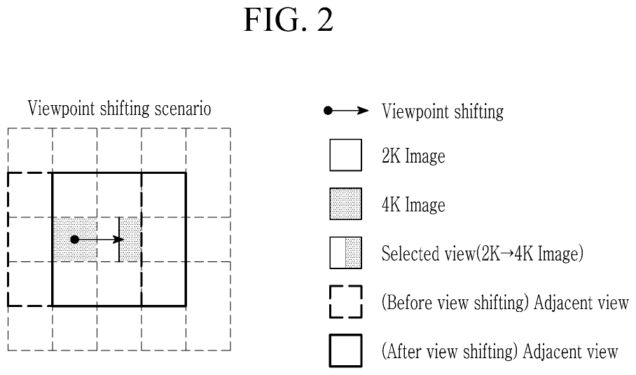

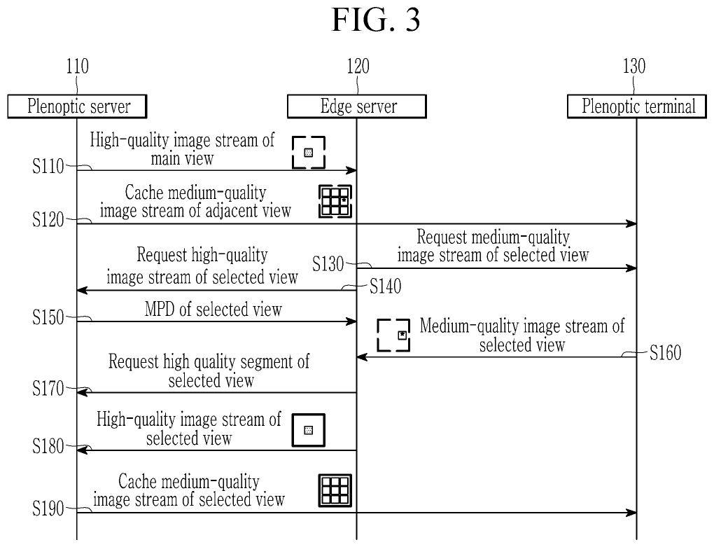

FIG. 1 is a block diagram illustrating a plenoptic system according to an embodiment, FIG. 2 is a conceptual diagram illustrating a shifting scenario of a viewpoint according to an embodiment, and FIG. 3 is a flowchart illustrating a method for transmitting and receiving a high-quality image provided by a plenoptic system according to an embodiment.

A plenoptic system according to an embodiment may provide seamless view switching to a terminal that displays images acquired from a plurality of high-definition cameras (2K cameras, 4K cameras, etc.) through dynamic adaptive streaming over HTTP (DASH) protocol.

Referring to FIG. 1, a plenoptic system 100 according to an embodiment may include a plenoptic server 110, an edge server 120, and a plenoptic terminal 130.

The plenoptic server 110 may separately configure an image stream obtained based on each viewpoint into a plurality of DASH segments of two resolutions (e.g., 2K and 4K), respectively. Here, the DASH segments having the two resolutions may be time-synchronized, respectively. The plenoptic server 110 may store the image stream including the DASH segments and transmit the stored image stream to the plenoptic terminal 130 and the edge server 120 according to a request from the plenoptic terminal 130.

The edge server 120 may be a cache server that receives and stores a medium-quality image (e.g., the 2K resolution image) of an adjacent view from the plenoptic server 110. The edge server 120 may be a server located at a physically or practically closest distance from the plenoptic terminal 130.

The plenoptic terminal 130 may output an image of a selected viewpoint selected by the user and transmit a user request for a view change (or a view shifting) to the plenoptic server 110.

FIGS. 2 and 3 illustrate a procedure for providing seamless view shifting to the user of the plenoptic terminal 130 by the plenoptic system 100 according to an embodiment when a plenoptic image including a plurality of viewpoints (e.g., 25 viewpoints in FIG. 2) is displayed on the terminal.

According to an embodiment, the plenoptic server 110 may transmit a high-quality image stream (e.g., 4K) for a specific viewpoint (e.g., main view) to the plenoptic terminal 130 (S110), and send, to the edge server 120, a medium-quality image stream (e.g., 2K) for eight adjacent views around the specific viewpoint (S120).

Referring to FIG. 2, a center segment of nine segments within a dotted line rectangle is a segment of a current viewpoint, and eight segments surrounding the segment of the current viewpoint are segments of adjacent views. That is, when the high-quality image of the specific viewpoint is being streamed from the plenoptic server 110 to the plenoptic terminal 130, a medium-quality image of the adjacent views of the corresponding specific viewpoint may be cached from the plenoptic server 110 to the edge server 120.

The large rectangles indicated in S110, S120, and S160 are dotted line rectangle boxes, and the large rectangles indicated in S180 and S190 are solid line rectangle boxes. The small square marked with an asterisk (*) in S120 and S160 is a segment of a selected viewpoint to be shifted from the current viewpoint. That is, the square including the asterisk may correspond to a center segment in the solid line rectangle box.

When the user's view is changed, the plenoptic terminal 130 may request a medium-quality image stream of the shifted viewpoint from the edge server 120 (S130), and then, the plenoptic terminal 130 may request information on the shifted viewpoint from the plenoptic server 110 (S140).

Referring to FIG. 2, the center segment of nine segments within the solid line rectangle is a segment of a shifted selected viewpoint, and eight segments surrounding the segment of the shifted viewpoint are segments of adjacent views of the shifted viewpoint. That is, the shifted viewpoint may be included in the segments of the adjacent views of a previous viewpoint that has been cached in the edge server 120.

The plenoptic server 110 receiving the request from the plenoptic terminal 130 may transmit a DASH media presentation description (DASH MPD) for streaming a high-quality image of the shifted viewpoint to the plenoptic terminal 130 (S150).

In addition, the edge server 120 receiving the request for the medium-quality image stream from the plenoptic terminal 130 may transmit the medium-quality image stream of the shifted viewpoint to the plenoptic terminal 130 (S160).

Referring to FIGS. 2 and 3, since the shifted selected viewpoint corresponds to the segment located on the right of the eight segments of the adjacent views before being shifted, the edge server 120 may provide the medium-quality image stream of the selected viewpoint to be shifted from the previous viewpoint from among the medium-quality image streams of the adjacent views of the previous viewpoint to the plenoptic terminal 130.

Thereafter, the plenoptic terminal 130 may request, based on the MPD of the selected viewpoint, the plenoptic server 110 to transmit a streaming of the high-quality image (S170), and the plenoptic server 110 may transmit the high-quality image stream of the shifted viewpoint through DASH-based streaming to the plenoptic terminal 130 (S180).

According to an embodiment, a distance between the edge server 120 and the plenoptic terminal 130 is closer than a distance between the plenoptic server 110 and the plenoptic terminal 130, and the amount of the medium-quality image stream is smaller than the amount of the high-quality image stream. Thus, the plenoptic terminal 130 may first receive the medium-quality image stream of the shifted viewpoint from the edge server 120 and start playing, and then receive the high-quality image stream for the shifted viewpoint from the plenoptic server 110 and start playing. Thereafter, the high-quality image stream of the shifted viewpoint may be continuously transmitted until the shifted viewpoint is shifted again from the plenoptic server 110 to the plenoptic terminal 130. In addition, when starting the high-quality image streaming for the shifted viewpoint, the plenoptic server 110 may cache the medium-quality image stream for the adjacent views of the shifted viewpoint in the edge server 120 (S190) simultaneously.

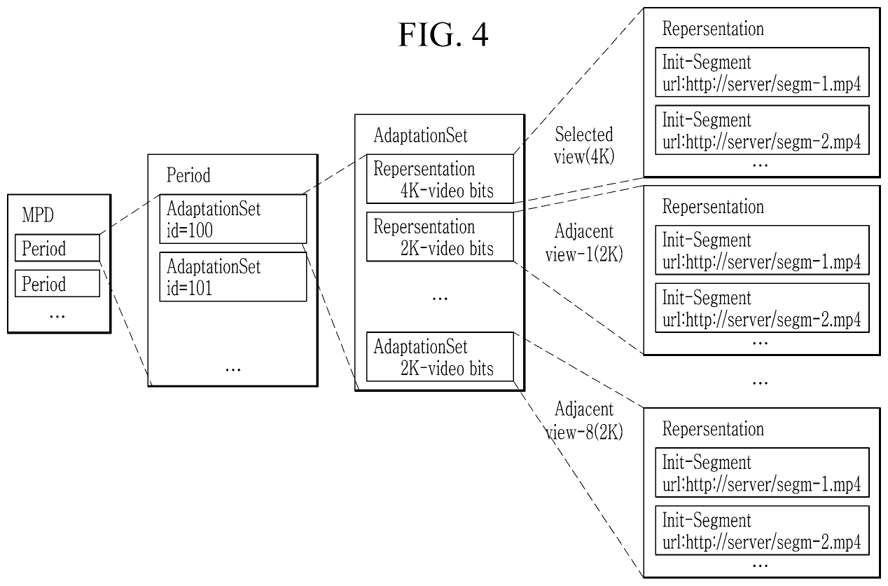

FIG. 4 is a diagram illustrating MPD data configured by a plenoptic server according to an embodiment.

A DASH MPD standard is defined to be described in the order of Period-AdaptationSet-Representation. The plenoptic server 110 according to an embodiment may describe information on the adjacent views (e.g., 8 segments) together in the AdaptationSet when streaming the high-quality image for the selected viewpoint (shifted viewpoint).

When requesting a view change, the plenoptic terminal 130 may search URL information of segments for the medium-quality image of the view to be shifted from the MPD information (Representation of the first adjacent view to the eighth adjacent view) and immediately request the medium-quality image stream of the selected viewpoint to be shifted from the edge server 120 based on the searched URL information.

The plenoptic server 110 and the plenoptic terminal 130 may update adjacent view information in the MPD information whenever the viewpoint is shifted/changed.

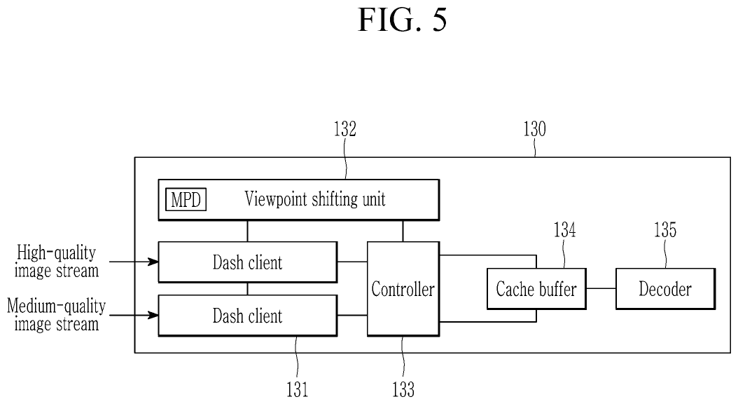

FIG. 5 is a block diagram illustrating a plenoptic terminal according to an embodiment.

Referring to FIG. 5, the plenoptic terminal 130 may include a DASH client 131, a viewpoint shifting unit 132, a controller 133, a cache buffer 134, and a decoder 135.

The DASH client 131 may be configured as two modules to receive a high-quality image stream and a medium-quality image stream, respectively, from the plenoptic server 110 and the edge server 120.

The viewpoint shifting unit 132 may store URL information on the adjacent views included in the MPD delivered through the high-quality image stream received from the plenoptic server 111, and when the viewpoint is changed, the viewpoint shifting unit 132 may inform each DASH client 131 and the controller 132 about the view change (or the view shifting).

The controller 133 may recognize that the viewpoint is changed and may transfer the segments of the medium-quality image stream received from the edge server 120 to the cache buffer until the segment of the high-quality image stream of the shifted viewpoint is received. After the segment of the high-quality image stream of the shifted viewpoint is received, the controller may determine whether to continue or stop receiving the segments of the medium-quality image stream according to a service policy.

The cache buffer 134 may store the high-quality image stream or the medium-quality image stream under the control of the controller.

The decoder 135 may decode the image streams delivered in the order stored in the cache buffer 134 and output images.

As described above, the plenoptic system 100 according to an embodiment may effectively provide an image streaming environment in which views may be switched seamlessly to multiple users by utilizing the edge server (or a cloud server) and MPD information.

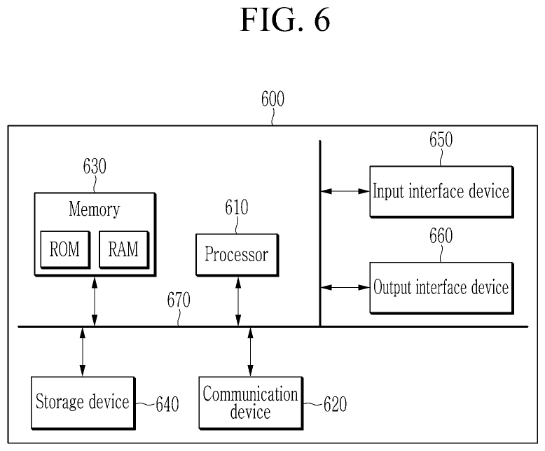

FIG. 6 is a block diagram illustrating a plenoptic terminal according to another embodiment.

An apparatus for transmitting and receiving an image in a plenoptic system according to an embodiment may be implemented in a computer system, for example, a computer-readable medium. Referring to FIG. 6, the computer system 600 may include at least one of a processor 610, a memory 630, an input interface device 650, an output interface device 660, and a storage device 640 communicating via a bus 670. The computer system 600 may also include a communication device 620 coupled to a network. The processor 610 may be a central processing unit (CPU) or a semiconductor device that executes instructions stored in the memory 630 or the storage device 640. The memory 630 and the storage device 640 may include various types of volatile or non-volatile storage mediums. For example, the memory may include read only memory (ROM) and random access memory (RAM). In the embodiment of the present disclosure, the memory may be located inside or outside the processor, and the memory may be connected to the processor through various known means. The memory may be a volatile or non-volatile storage medium of various types. For example, the memory may include a read-only memory (ROM) or a random access memory (RAM).

Accordingly, an embodiment may be implemented as a computer-implemented method or as a non-transitory computer-readable medium having computer-executable instructions stored thereon. In an embodiment, when executed by a processor, computer readable instructions may perform a method according to at least one aspect of the present disclosure.

The communication device 620 may transmit or receive wired signals or wireless signals.

The embodiments are not only embodied by the above-mentioned method and apparatus. Alternatively, the above-mentioned embodiments may be embodied by a program performing functions that correspond to the configuration of the embodiments, or a recording medium on which the program is recorded. These embodiments can be easily devised from the description of the above-mentioned embodiments by those skilled in the art to which the present description pertains. Specifically, the method (e.g., network management method, data transmission method, transmission schedule generation method, etc.) according to the embodiment is implemented in the form of a program command that can be executed through various computer means, and can be recorded in a computer-readable medium. The computer-readable medium may include program instructions, data files, data structures, and the like, alone or in combination. The program instructions recorded on the computer-readable medium may be specially designed and configured for the embodiment, or may be known and available to those skilled in the art of computer software. The computer-readable recording medium may include a hardware device configured to store and execute program instructions. For example, the computer-readable recording medium includes magnetic media such as hard disks, floppy disks and magnetic tapes, optical recording media such as CD-ROMs and DVDs, and magneto-optical media, such as a floptical disk, ROM, RAM, flash memory, or the like. The program instructions may include not only machine language codes such as those generated by a compiler, but also high-level language codes that can be executed by a computer through an interpreter or the like.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A method for receiving an image by a plenoptic terminal, the method comprising:
receiving, from a plenoptic server, a high-quality image stream of a first viewpoint;
requesting, from the plenoptic server, information on a second viewpoint to be shifted when a user's view is shifted, and requesting, from an edge server, a medium-quality image stream of the shifted second viewpoint;
receiving, from the edge server, the medium-quality image stream of the second viewpoint and playing the received medium-quality image stream; and
receiving the information on the second viewpoint and subsequently playing a high-quality image stream of the second viewpoint received from the plenoptic server.

2. A method for transmitting an image by a plenoptic server, the method comprising:
transmitting, to a plenoptic terminal, a high-quality image stream of a first viewpoint and cashing a medium-quality image stream of the first viewpoint to an edge server;
receiving, after a user's view is shifted, a request of information on a second viewpoint to be shifted transmitted from the plenoptic terminal and providing a high-quality image stream of the second viewpoint to the plenoptic terminal; and
cashing a shifted medium-quality image stream of the second viewpoint to the edge server.
